(19) United States
(12) Patent Application Publication
(10) Pub. No.: US 2008/0294483 A1
(43) Pub. Date: Nov. 27, 2008

(54) FREE TIME PRIORITY FOR CALENDAR SCHEDULERS

(76) Inventor: Oriana Jeannette Williams, Austin, TX (US)

Correspondence Address: IBM CORP (YA);C/O YEE & ASSOCIATES PC, P.O. BOX 802333, DALLAS, TX, 75380, US

(21) Appl. No.: 11/754,005

(22) Filed: May 25, 2007

(51) Int. Cl. G06F 9/50

(52) U.S. Cl. 705/8

(57) ABSTRACT

A method, apparatus and computer program product for schedules common time intervals and reserves free time for a plurality of users in a network environment. An initial free time block is reserved, including corresponding user-defined time reallocation parameters. In the event of a potentially conflicting event arising, parameters of the potentially conflicting event are compared with the requested time block to determine if and how the reserved time block can be apportioned into at least one reallocated new time block. Reapportioning can occur if the parameter of the potentially conflicting event does not violate the corresponding user-defined time reallocation parameters.

### BACKGROUND OF THE INVENTION

1. Field of the Invention

The present invention relates generally to an improved data processing system and in particular to a method and apparatus for network-based electronic calendars, schedulers, and tasking systems for groups of users. Still more specifically, the present invention relates to a computer implemented method, apparatus, and computer usable program for reallocating reserved free time in a group based calendar.

2. Description of the Related Art

As offices move towards a more network-based working environment, computer implemented personal calendars are becoming more prevalent. These network based calendars are used for keeping records and reminding users of important events, such as meetings, deadlines, and other important events.

Personal calendars can be provided by a shared network. Events stored in networked calendars are often viewable by each user of the network. This sharing of personal calendars allows people to view available time slots for other users so that group meetings or other events can be scheduled during time slots when the required meeting participants all have intersecting unscheduled “free” time. Although this convenience has allowed people to coordinate with greater ease, it often contributes in robbing individuals of this free time outside of meetings.

Individuals routinely have other workplace responsibilities outside of attending these group meetings that require a set amount of time during the day to complete. This time is often not scheduled on the individual's personal calendar. Thus, other users looking at an individual's personal calendar will see a time slot as free, despite the individual performing other workplace responsibilities during that time slot.

One solution that many individuals have manually done to get around their lack of free time is to budget for this time on their calendar. For example, an individual may set aside three continuous hours in the morning where they know they need to get their workplace responsibilities completed. Unfortunately, a meeting or other event may arise suddenly that requires that individual's attendance. By looking at the individual's networked personal calendar, the meeting scheduler first sees that this person is busy during the required meeting time. However, if the meeting time slot is the only time slot during which other required individuals can also meet, the meeting scheduler must manually identify an acceptable alternative meeting time. The meeting scheduler often contacts the individual to ensure the conflict scheduled on their personal calendar is an actual conflict. When so confronted, the individual reveals that the three hour reserved time block is movable and that individual is in fact available to meet during the required meeting time.

Similarly, the individual may be forced to partition the reserved three hour time block to accommodate the current meeting, or to accommodate other arising new meetings and other existing previously scheduled meetings. This constant reshuffling of an individual's calendar to accommodate group meetings and activities can be detrimental to the individual's productivity throughout the day, and can result in a delay in completion of those individual workplace responsibilities. Likewise, productivity of the meeting scheduler also suffers while tracking down individuals with conflicts and determining the merits of the conflicting scheduled time blocks in the personal calendars for these individuals.

This manual method of free time scheduling is a source of inefficiency and inconvenience to both the individual and the scheduler of the meeting.

### SUMMARY OF THE INVENTION

The present invention provides a method, apparatus and computer program product for scheduling common time intervals and reserving free time for a plurality of users in a network environment. An initial free time block is reserved, including corresponding user-defined time reallocation parameters. In the event of a potentially conflicting event arising, parameters of the potentially conflicting event are compared with the requested time block to determine if and how the reserved time block can be apportioned into at least one reallocated new time block. Reapportioning can only occur if the parameter of the potentially conflicting event does not violate the corresponding user-defined time reallocation parameters.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating a dataflow when a client utilizes a free time priority calendar scheduler provided by a server in accordance with an illustrative embodiment;

FIG. 4 is a flowchart illustrating a process for a server providing a free time priority calendar scheduler to a client in accordance with an illustrative embodiment; and

FIG. 5 is a flowchart illustrating a process for a client utilizing a free time priority calendar scheduler in accordance with an illustrative embodiment.

### DETAILED DESCRIPTION OF THE PREFERRED EMBODIMENT

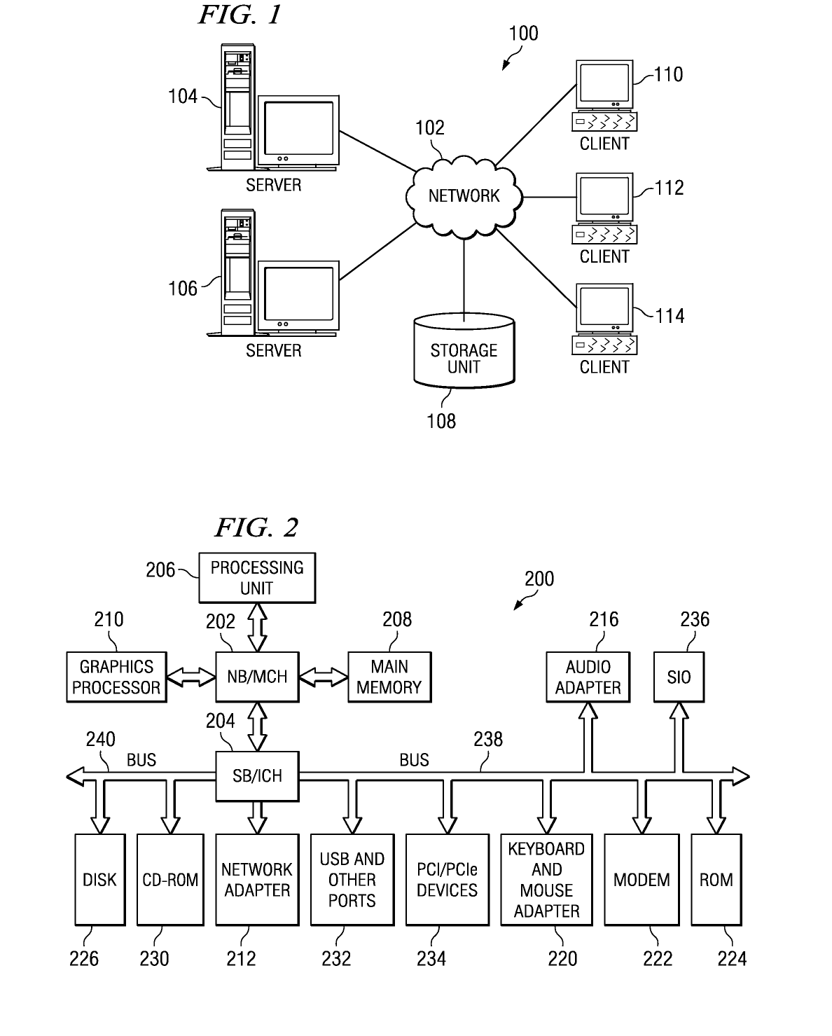

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Server 104 may include processes for hosting online applications and executing applications such as a networked calendar. Events stored in a personal calendar on the networked calendar are viewable by other users of network data processing system 100 in addition to the owner of the personal calendar. The sharing of personal calendars allows people to view available time slots for other users so that group meetings or other events can be scheduled during time slots when the required meeting participants all have intersecting unscheduled “free” time. Each owner of a personal calendar has access to the networked calendar to schedule events on the calendar. Additionally, other authorized personnel may also have access to the personal calendars of other users to schedule meetings and events for those other users.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The different embodiments recognize that free time and event scheduling (and rescheduling) need not be a manual process; rather, the functionality of an individual's personal calendar could be expanded to support a flexible yet guaranteed amount of time reserved for individual responsibilities during the workday. The scheduler may be capable of priority-based scheduling of events; a lower priority event may be previously scheduled, but might have to yield to a higher priority, subsequently scheduled event. Additionally, other parameters associated with the lower priority event are complied before a rescheduling of a time block can occur.

The different illustrative embodiments provide a computer implemented method, apparatus, and computer usable program code for scheduling blocks of free time. An initial free time block is reserved, including corresponding user-defined time reallocation parameters. In the event of a potentially conflicting event arising, reallocation parameters of the potentially conflicting event are compared with the preferred free time block to determine if and how the initial free time block can be apportioned into at least one reallocated time block. Reapportioning occurs in these examples if the parameter of the potentially conflicting event does not violate the corresponding user-defined time reallocation parameters.

The new event and its associated reallocation parameters are then stored in a memory or storage unit of the personal calendar. An attempt to reschedule the time block of the new event will cause a server process to recall the new associated reallocation parameters. The process then uses the new parameters to determine whether the new event can be rescheduled.

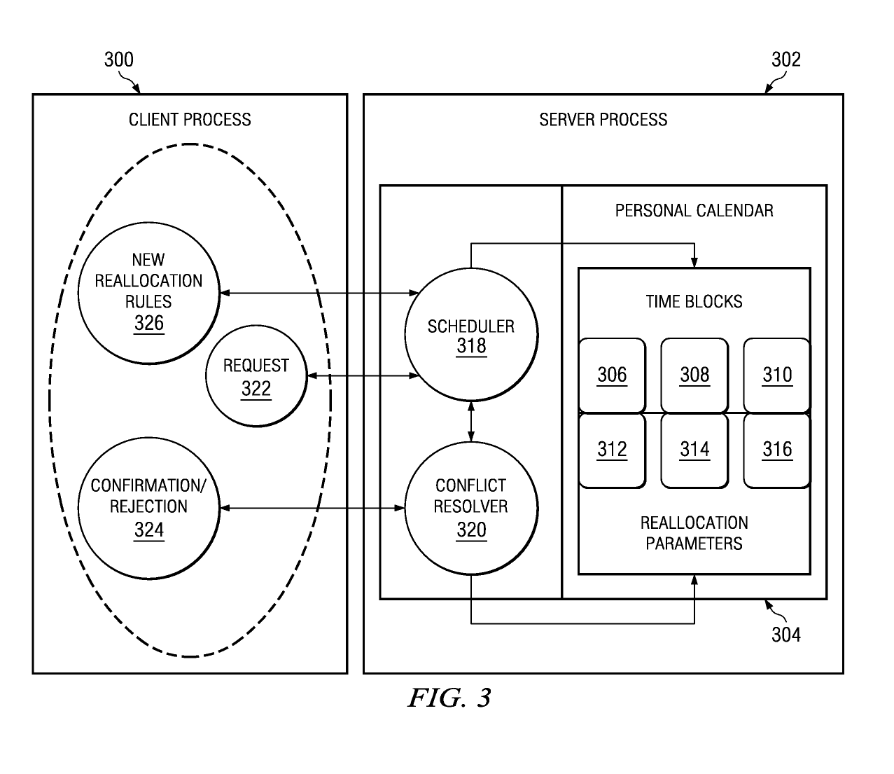

Turning now to FIG. 3, a block diagram is shown, illustrating a dataflow when a client utilizes a free time priority calendar scheduler provided by a server in accordance with an illustrative embodiment. Client process 300 is implemented in any type of general computing device. In this example, client process 300 is a process that executes on a client, such as client 110 in FIG. 1.

Server process 302 is a process that provides networked personal calendar 304 including for utilization by an individual. Server process 302 is a process that executes on a server, such as server 104 in FIG. 1. In other words, server process 302 may include processes for serving web pages, hosting online applications, executing applications, providing web services and/or any other type of processes associated with a server. For example, web server process 302 may include any known or available software processes and components for managing applications (not shown), including but not limited to, components for receiving requests, executing applications, sending an application to a client, initiating a session between server process 302 and client process 300, authenticating client process 300, and/or any other processes performable by a server. Server process 302 may be a hardware server, a software server, or a server having a combination of hardware and software components.

Server process 302 can be a server on a network, such as network 102 described in FIG. 1. Client process 300 is connected to networked calendar applications of server process 302 through a network connection via a network device (not shown). The network device may be any type of network access software for allowing client process 300 to access a network, such as the Internet. The network device connects to a network connection, such as network 102 in FIG. 1. The network connection permits access to any type of network, such as a local area network (LAN), a wide area network (WAN), an intranet, an Ethernet, or the Internet. In this example, client process 300 connects to web server process 302 via an Intranet connection.

A networked calendar includes a personal calendar 304 for each user stored on the data processing server. Personal calendar 304 is a user specific daily schedule of events broken down into different time blocks 306, 308, 310. That is, each user of the network has a unique personal calendar 304. Time blocks 306, 308, 310 are temporal divisions of each day, such as hourly or sub-hourly divisions, in which various events can be scheduled. An individual can access his unique personal calendar 304 for the scheduling of events and reservation of free time. Certain other persons, such as supervisors and network administrators, have access to the personal calendars of each individual. These other persons can reserve time blocks 306, 308, 310 in any personal calendar 304 for individual or group-based events or meetings that requiring the calendar owner's attendance.

Personal calendar 304 may be associated with a server computer hosting and executing an online application. In this case, the personal calendar is provided in an online operating environment. An online operating environment is an operating environment that includes a network connection between the client device and the server.

A time block may be free or reserved. A free time block is a block of time that has not yet been reserved or allocated for an event or other purpose, such as other workplace responsibilities. A reserved time block is one that has previously been allocated to a specific event. Each reserved time block has associated reallocation parameters. An event is any scheduled activity on an individual's personal calendar 304. Events can include events such as inter-office meetings, presentations, client meetings, as well as time reserved for non-communal work related responsibilities. Events can further include personal events taking place during the workday, such as doctor's appointments, luncheon meetings, and vacation days.

One or more reallocation parameters 312, 314, 316 provide the specific circumstances under which the reserved time block may be superseded, partitioned, or reallocated and then replaced by a conflicting event. The reallocation parameters indicates at a minimum whether the reserved time block is preemptive, or is capable of yielding to a more important event that is yet to be scheduled. The reallocation parameters can include minimum and maximum time block thresholds for reallocated time, and a hard cut-off date past which a certain block of time cannot be rescheduled. Reallocation parameters may also include acceptable timeframes during which the reallocation may occur, such as the minimum amount of time that must be given prior to reallocating a certain time block. An indication of whether the time block is partitionable may also be provided, including a maximum number of partitioned blocks, as well as a minimum time block for each of those partitions. Reallocation parameters can be user-defined, so that different parameters can be associated with different events and time blocks.

Scheduler 318 is a software process that receives request 322 from the client to reserve time blocks 306, 308, 310. Scheduler 318 determines whether the requested meeting time conflicts with any reserved times and their corresponding reserved times block in the personal calendar. This determination can be effectuated through recalling a reserved/free designation of a requested time block. In the event of a conflict, the scheduler 318 forwards the conflicting time block request from the client process 300 to conflict resolver 320. Scheduler 318 also receives conflict and time block reallocation information from conflict resolver 320, schedules the time blocks 306, 308, 310 in the personal calendar 304, and designates those time blocks as reserved. Scheduler 318 also associates new reallocation parameters with any new event being scheduled in a particular time block.

Conflict resolver 320 is a software process that retrieves time blocks 306, 308, 310 including reserved time and free time designations, as well as reallocation parameters 312, 314, 316 from a personal calendar 304 in response to a request by the scheduler 318. The conflict resolver recalls associated reallocation parameters for conflicting events in the requested time block. The conflict resolver applies reallocation parameters 312, 314, 316 for any conflicting reserved times in a requested time block in determining a reallocated time block in which to reschedule the previously scheduled conflicting event. The conflict resolver also communicates to the scheduler 318 conflicts as well as any relocated time blocks into which an associated event is rescheduled.

In these examples, the networked calendar includes personal calendar 304 for an individual. For simplicity, only one personal calendar is shown. However, the networked calendar may consist of any number of personal calendars, each being associated with a certain individual. These calendars are stored on server process 302 in these examples. Each personal calendar 304 is broken down into different time blocks 306, 308, 310. Time blocks are temporal divisions of each day, such as hourly or sub-hourly divisions, in which various events can be scheduled. Preferably, each individual using the network has a unique personal calendar.

In this example, a connected client device, such as client 110 of FIG. 1 initiates a personal calendar, such as personal calendar 304, in the networked calendar utilizing the server process 302. In response to an attempt to reserve a time block, such as time block 306, for a new event in the personal calendar, the server process checks the personal calendar of the individual to determine if the requested time block is free. To effectuate the process, scheduler 318 receives time block request 322 from client process 300. Scheduler 318 determines whether the requested time block conflicts with any reserved times and their corresponding reserved times in the personal calendar by comparing the requested time block for the new event with events that were previously scheduled in time blocks 306, 308, and 310. The server process man also recall a reserved/free designation of the requested time block. In this example, scheduler 318 determines that the requested time block for the new event is free of any conflicting previously scheduled events.

When the requested time block is free, the server process 302 reserves the requested time block for the new event. Scheduler 318 records the new event in time blocks 306, 308, and 310 of the personal calendar 304, and designates those time blocks as reserved. Confirmation event 324 is then sent to client process 300 running on a client such as client 110 of FIG. 1.

Server process 302 then prompts the individual scheduling the event for entry of reallocation parameters 326 to be associated with that reserved time block. The new reallocation parameters will be associated with and correspond to the new event. In response, client process 300 determines, through input by the individual, new reallocation parameters corresponding to the new event. The new reallocation parameters can be manually entered by a user of a client device. Server process 302 associates new reallocation parameters 326 with the new event in the particular time block. The new reallocation parameters are stored in the associated memory location of personal calendar 304.

In another embodiment, if a request for a new meeting shows a time block 306, 308, and 310 has been previously reserved, associated reallocation parameters 312, 314, and 316 for the reserved time block are recalled. Scheduler 318 receives time block request 322 from client process 300. Scheduler determines whether the requested time block conflicts with any previously scheduled event stored in a time block 306, 308, 310 of the personal calendar 304. This can be through the recalling a reserved/free designation of the time blocks 306, 308, 310 which corresponds to the time block request. In this example, scheduler 318 determines that time blocks 306, 308, and 310 corresponding to time block request 322 have a conflicting previously scheduled event.

Server process 302 compares the conflicting event with available free time blocks in the personal calendar, and the reallocation parameters of the conflicting event. Having determined a conflict, scheduler 318 forwards time block request 322 to the conflict resolver 324. In response to receiving the time block request of the conflicting time block, the conflict resolver recalls associated reallocation parameters 312, 314, and 316 for conflicting events in the time block corresponding to time block request 322. The conflict resolver then applies the reallocation parameters for the time block corresponding to time block request 322 to determine if an acceptable reallocated time block can be found in which to reschedule the conflicting event.

In the event that an acceptable reallocated time block complying with each of the reallocation parameters cannot be located, server process 302 does not schedule the new event in the time block of the time block request 322. Conflict resolver 320 communicates back to the scheduler 318 that an acceptable reallocated time block can not be found. The conflicting originally scheduled event remains scheduled in that requested time block. The scheduler 318 then informs the client process 300 that an acceptable reallocated time block could not be determined and that request 322 and the associated event were not scheduled on personal calendar 304. The individual can then attempt to identify a different time block in the personal calendar during which the new event can be scheduled.

If server process 302 is able to determine acceptable reallocated time blocks in which to reschedule the conflicting event, the server process 302 will reschedule the conflicting event in those reallocated time blocks. Conflict resolver 320 communicates back to scheduler 318 that an acceptable reallocated time block is found. This communication informs the scheduler of the acceptable reallocated time block and the event to be associated with the reallocated time block.

Server process 302 then disassociates the associated reallocation parameters with the original time block, and re-associates the associated reallocation parameters with the time blocks into which the conflicting event was rescheduled. Upon receiving notification from conflict resolver 320 that a determination of an acceptable reallocated time block has been determined and receives the associated reallocated time block information, the scheduler records the conflicting previously scheduled event into the reallocated time block. Scheduler 318 reschedules the conflicting previously scheduled event to the acceptable reallocated time block. The reallocation parameters for the conflicting previously scheduled event are specific to the event that is scheduled in the time block, and not specific to the time block itself. The reallocation parameters for conflicting previously scheduled event remain associated with that event even after reallocation.

The reallocation parameters may also be updated to include a reallocation counter. The reallocation counter would increment each time that the conflicting previously scheduled event is rescheduled. Upon the reallocation counter reaching a predetermined number, the conflicting previously scheduled event would no longer be available for rescheduling. Thus, an event could be reallocated up to n times. Upon the n^{th} reallocation, the event could no longer be rescheduled. Future events must then be scheduled to accommodate the previously scheduled event.

Scheduler 318 may further designate the reallocated time blocks as reserved. Reallocation parameters that were previously associated with the first event remain associated with the first even after reallocation, such that any subsequent reallocation of the first event will also have to comply with the associated reallocation parameters.

After reallocation, time blocks previously associated with the previously scheduled event are now associated with the new event. Time blocks now associated with the new event retain their reserved designation. Reallocated time blocks are now associated with the conflicting previously scheduled event.

In response to scheduling a new event in a certain time block, server process 302 prompts the scheduler for entry of new reallocation parameters to correspond to the newly scheduled event. Scheduler 318 prompts client process 300 for submission of new reallocation parameters 326 to be associated with the new event. Upon receipt of the submission from the client, the process then associates the new reallocation parameters 326 with the new event. Scheduler associates new reallocation parameters 326 with the new event. Any attempted rescheduling of the new event must then comply with new reallocation parameters 326.

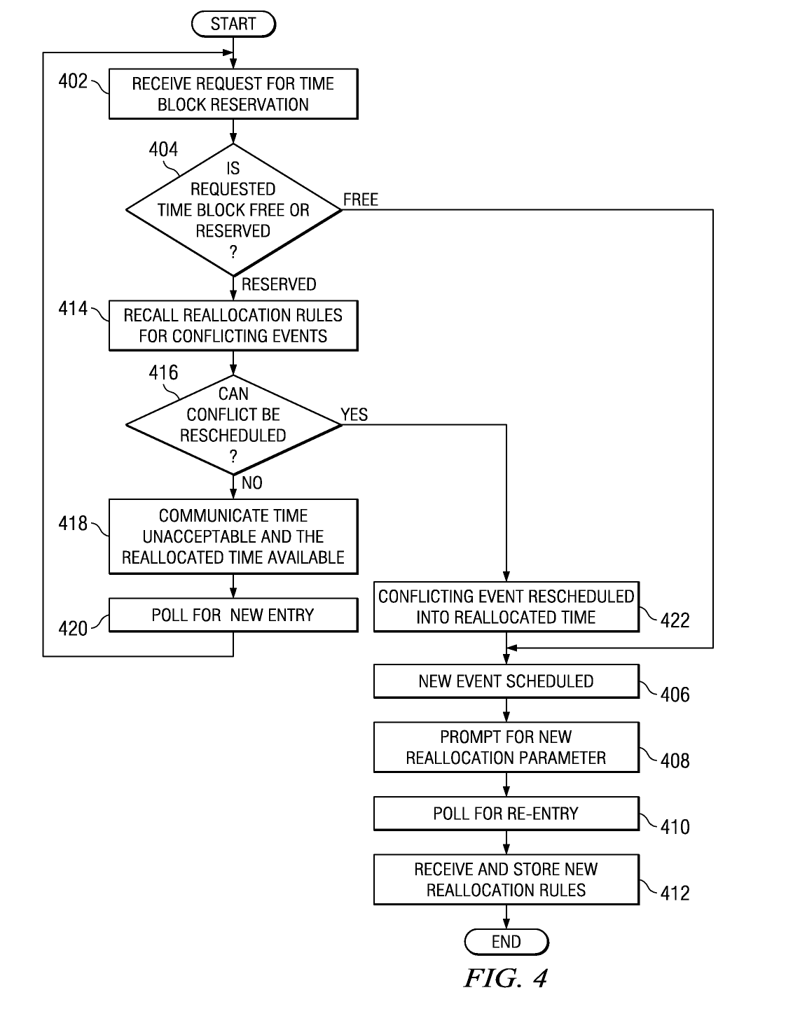

Turning now to FIG. 4, a flowchart illustrating a process for a server providing a free time priority calendar scheduler to a client is shown in accordance with an illustrative embodiment. The process in FIG. 4 may be implemented by a software component for providing a free time priority calendar scheduler to a client. For example, the process may be implemented by a server process, such as server process 302 in FIG. 3.

The process begins by receiving a request to reserve a requested time block corresponding to a new event (step 402). In response to this request, the process determines whether the requested time block has previously been reserved by a previous event (step 404). The determination in these examples can be made through the recalling of a reserved/free designation of the requested time block in a personal calendar, such as personal calendars 304 in FIG. 3.

If the requested time block is designated as free, the process records the new event in the requested time blocks of the personal calendars, and designates those time blocks as reserved (step 406). The process then prompts the client for entry of new reallocation parameters corresponding to the new event (step 408), and begins polling for a response (step 410). In response to receiving new corresponding reallocation parameters, the process associates new reallocation parameters with the new event in the particular time block, and stores the reallocation parameters in an associated memory location (step 412), with the process terminating thereafter.

If the requested time block is designated as reserved, the process recalls associated conflicting reallocation parameters for previously scheduled conflicting event in the requested time block (step 414). The process then applies the conflicting reallocation parameters for the conflicting event to determine if an acceptable reallocated time block can be found in which to reschedule the conflicting event (step 416).

In the event that an acceptable reallocated time block cannot be determined (“no” at step 416), the process communicates, that the time is unacceptable and the current time block request and associated event were not scheduled on the personal calendar because an acceptable reallocated time block for the conflicting event could not be identified (step 418).

The process may then poll the client for entry of a new time block (step 420). The process then returns to step 402, and again attempts to schedule the new event.

Returning now to step 416, in the event that an acceptable reallocated time block is found (“yes” at step 416), the process reschedules the previously conflicting event into the acceptable reallocated time block and designates the acceptable reallocated time blocks as reserved (step 420). The reallocation parameters for the conflicting event remain associated with the conflicting event, now rescheduled into the reallocated time block, such that future attempts to schedule into the reallocated time block must comply with the reallocation parameters of the original conflicting event.

In an illustrative embodiment, the reallocation parameters may also be updated to include a reallocation counter. The reallocation counter would increment each time that the conflicting previously scheduled event is rescheduled. Upon the reallocation counter reaching a predetermined number, the conflicting previously scheduled event would no longer be available for rescheduling. Thus, an event could be reallocated up to n times. Upon the n^{th} reallocation, the event could no longer be rescheduled. Future events must then be scheduled to accommodate the previously scheduled event.

The process then schedules the new event into the requested time block (step 406). If not already designated as such, the process may also designate the requested time block as reserved.

The process then prompts the client for entry of new reallocation parameters corresponding to the new event (step 408), and begins polling for a re-entry (step 410). The re-entry in step 410 is a response from the client in these examples. In response to receiving new corresponding reallocation parameters the process associates the new reallocation parameters with the new event in the particular time block, and stores the new reallocation parameters in an associated memory location (step 412), with the process terminating thereafter.

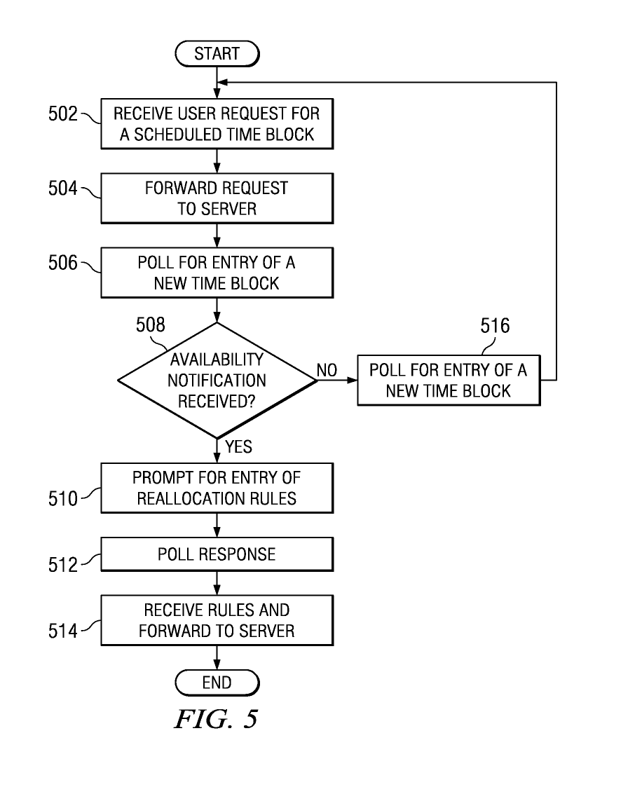

Turning now to FIG. 5, a flowchart illustrating a process for a client utilizing a free time priority calendar scheduler is shown in accordance with an illustrative embodiment. The process in FIG. 5 may be implemented by a software component providing a free time priority calendar scheduler to a client. For example, the process may be implemented by a client process, such as client process 300 in FIG. 3.

The process begins by receiving a user request to reserve a requested time block corresponding to a new event (step 502). In response to the request, the process sends the request to a server (step 504), such as server process 302 in FIG. 3, and begins to poll for a response (step 506). The server determines whether the requested new time block has previously been reserved by a previous event (step 508).

If the requested time block is designated as free, the server records the new event in the requested time blocks of the personal calendars, and designates those time blocks as reserved. The process receives notification from the server that either the requested time block is free and has been reserved for the new event, or the requested time block is unavailable and an acceptable reallocated time block for the conflicting event could not be determined (step 508).

In the event that the requested time block is free, the process then prompts the user for entry of new reallocation parameters corresponding to the new event (step 510), and begins polling for a response from the user (step 512). In response to receiving new corresponding reallocation parameters from the user, the process forwards the new corresponding reallocation parameters to the server for association with the new event in the particular time block (step 514).

Returning to step 508, if the requested time block is designated as reserved, the server recalls associated conflicting reallocation parameters for previously scheduled conflicting event in the requested time block. The server then applies the conflicting reallocation parameters for the conflicting event to determine if an acceptable reallocated time block can be found in which to reschedule the conflicting event.

In the event that an acceptable reallocated time block can not be determined, the process receives a communication from the server that the current time block request and associated event were not scheduled on the personal calendar because an acceptable reallocated time block for the conflicting event could not be determined (step 508). The process may then poll the user client for entry of a new time block (step 516). The process then returns to step 502, and attempts again to schedule the new event.

In the event that an acceptable reallocated time block is found, the server reschedules the previously conflicting event into the acceptable reallocated time block and designates the acceptable reallocated time blocks as reserved. The reallocation parameters for the conflicting event remain associated with the conflicting event, now rescheduled into the reallocated time block, such that future attempts to schedule into the reallocated time block must comply with the reallocation parameters of the original conflicting event.

In an illustrative embodiment, the reallocation parameters may also be updated to include a reallocation counter. The reallocation counter would increment each time that the conflicting previously scheduled event is rescheduled. Upon the reallocation counter reaching a predetermined number, the conflicting previously scheduled event would no longer be available for rescheduling. Thus, an event could be reallocated up to n times. Upon the n^{th} reallocation, the event could no longer be rescheduled. Future events must then be scheduled to accommodate the previously scheduled event.

The server then schedules the new event into the requested time block. If not already designated as such, the server also designates the requested time block as reserved.

The process may optionally receive a communication from the server that the new event was scheduled into the requested time block and that the previously conflicting event was rescheduled into an acceptable reallocated time block and designates the acceptable reallocated time blocks as reserved (step 508). The process then prompts the user for entry of new reallocation parameters corresponding to the new event (step 510), and begins polling for a response (step 512). In response to receiving new corresponding reallocation parameters the process forwards the new reallocation parameters to the server for association with the new event in the particular time block (step 514).

Thus, the illustrative embodiments provide a computer implemented method for managing schedules. Responsive to receiving a request to schedule an event for a time block in a calendar for a user, the method determines whether the time block conflicts with a reserved time block in the personal calendar. If a conflict with a reserved time block exists, the method identifies parameters for handling reallocation of the reserved time block. The method applies the parameters to determine whether to reschedule the reserved time block. Responsive to a determination to reschedule the reserved time block, the method schedules the event in the time block. Finally, the previously conflicting event is rescheduled into an acceptable reallocated time block.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing schedules, the computer implemented method comprising:
responsive to receiving a request to schedule an event for a requested time block in a calendar, determining whether a conflict is present between the requested time block conflicts and a reserved time block in the calendar;
responsive to the conflict being present, identifying parameters for handling reallocation of the reserved time block;
applying the parameters to the conflict to determine whether to reschedule the reserved time block;
responsive to a determination to reschedule the reserved time block, scheduling the event in the requested time block; and
rescheduling the reserved time block into a new time block if the event is scheduled in the requested time block that conflicts with reserved time block.

2. The method of claim 1 wherein the parameters are user-defined time reallocation parameters.

3. The method of claim 2, wherein the user-defined time reallocation parameters are selected from the list consisting of a net minimum daily required free time, an indication of whether the initial free time block is partitionable, a time window into which the initial free time block must be reallocated, a minimum forewarning before reallocating the initial free time block, an indication of whether the initial free time block is preemptible, an indicator of free time priority, a minimum acceptable time block for the reallocated time block, a reallocation counter, and combinations thereof.

4. The method of claim 1, wherein the conflict is selected from the group consisting of a time duration of the at least one potentially conflicting event, a start time of the at least one potentially conflicting event, an end time of the at least one potentially conflicting event, a priority indicator for the at least one potentially conflicting event, and combinations thereof.

5. The method of claim 1, wherein the at least one reallocated time block is a plurality of partitioned reallocated time blocks, each of the plurality of partitioned reallocated time blocks exceeding a minimum acceptable time block.

6. A computer program product for managing schedules, the computer program product comprising:
responsive to receiving a request to schedule an event for a requested time block in a calendar, first instructions for determining whether the requested time block conflicts with a reserved time block in the calendar;
responsive to a conflict being present, second instructions for identifying a parameters for handling reallocation of the reserved time block;
third instructions for applying the parameters to the conflict to determine whether to reschedule the reserved time block;
responsive to a determination to reschedule the reserved time block, fourth instructions for scheduling the event in the requested time block; and
fifth instructions for rescheduling a reserved time block into a new time block.

7. The computer program product of claim 6 wherein the parameters are user-defined time reallocation parameters.

8. The computer program product of claim 6, wherein the user-defined time reallocation parameters are selected from the list consisting of a net minimum daily required free time, an indication of whether the initial free time block is partitionable, a time window into which the initial free time block must be reallocated, a minimum forewarning before reallocating the initial free time block, an indication of whether the initial free time block is preemptible, an indicator of free time priority, a minimum acceptable time block for the reallocated time block, and combinations thereof.

9. The computer program product of claim 6, wherein the conflict is selected from the group consisting of a time duration of the at least one potentially conflicting event, a start time of the at least one potentially conflicting event, an end time of the at least one potentially conflicting event, a priority indicator for the at least one potentially conflicting event, a reallocation counter, and combinations thereof.

10. The computer program product of claim 6, wherein the at least one reallocated time block is a plurality of partitioned reallocated time blocks, each of the plurality of partitioned reallocated time blocks exceeding a minimum acceptable time block.

11. An apparatus comprising:
a bus system;
a communications system connected to the bus system;
a memory connected to the bus system, wherein the memory includes computer usable program code; and
a processing unit connected to the bus system, wherein the processing unit executes the computer usable program code to initiate an application for managing schedules; responsive to receiving a request to schedule an event for a requested time block in a calendar for a user, the computer usable program code determining whether the requested time block conflicts with a reserved time block in the calendar; responsive to a conflict being present, the computer usable program code identifying a parameters for handling reallocation of the reserved time block; the computer usable program code applying the parameters to the conflict to determine whether to reschedule the reserved time block; responsive to a determination to reschedule the reserved time block, the computer usable program code scheduling the event in the requested time block; and the computer usable program code rescheduling a reserved time block into a new time block.

12. The apparatus of claim 11 wherein the time reallocation parameters are user-defined time reallocation parameters.

13. The apparatus of claim 11, wherein the user-defined time reallocation parameters are selected from the list consisting of a net minimum daily required free time, an indication of whether the initial free time block is partitionable, a time window into which the initial free time block must be reallocated, a minimum forewarning before reallocating the initial free time block, an indication of whether the initial free time block is preemptible, an indicator of free time priority, a minimum acceptable time block for the reallocated time block, a reallocation counter, and combinations thereof.

14. The apparatus of claim 11, wherein conflict is selected from the group consisting of a time duration of the at least one potentially conflicting event, a start time of the at least one potentially conflicting event, an end time of the at least one potentially conflicting event, a priority indicator for the at least one potentially conflicting event, and combinations thereof.

15. The apparatus of claim 11, wherein the at least one reallocated time block is a plurality of partitioned reallocated time blocks, each of the plurality of partitioned reallocated time blocks exceeding a minimum acceptable time block.
